(19) United States
(12) Patent Application Publication
(10) Pub. No.: US 2019/0023528 A1
(43) Pub. Date: Jan. 24, 2019

(54) WIRELESS BEACON AND SENSOR NODE NETWORK APPLICATION FOR THE OPTIMIZATION AND AUTOMATION OF ON-SITE HOIST OPERATION AND VERTICAL TRANSPORTATION

(71) Applicants: George Franco, Miramar, FL (US); Morgan Stewert, Fort Lauderdale, FL (US); Megan Mackay, Plantation, FL (US)

(72) Inventors: George Franco, Miramar, FL (US); Morgan Stewert, Fort Lauderdale, FL (US); Megan Mackay, Plantation, FL (US)

(21) Appl. No.: 16/044,003

(22) Filed: Jul. 24, 2018

Related U.S. Application Data
(60) Provisional application No. 62/536,329, filed on Jul. 24, 2017.

(51) Int. Cl. B66B 1/46; H04W 40/24; H04L 29/08; H04W 4/80

(52) U.S. Cl. CPC B66B 1/468; H04W 40/244; B66B 2201/101; H04W 4/80; B66B 2201/4653; H04L 67/12

(57) ABSTRACT

A wireless beacon and sensor node network can be integrated with a wireless network at a worksite to enable the operators of the vertical transport apparatuses to efficiency optimize operations by automatically detecting worker and object location and quantity throughout a worksite and prioritizing vertical transport apparatus movement based on transport and/or material requests from workers in physical proximity to the vertical transport apparatus/system.

### PRIORITY OF INVENTION

The present invention claims priority as a continuation of U.S. Provisional Patent Application Ser. No. 62/536,329, filed Jul. 24, 2017, entitled “wireless beacon and sensor node network application for the optimization and automation of on-site hoist operation and vertical transportation”, which is hereby incorporated by reference.

### FIELD OF THE INVENTION

The present invention relates to a wireless beacon and sensor node network that can be integrated with existing on-site hoist and vertical transportation apparatuses responsible for the vertical transportation of people and objects (“assets”) such as materials and tools along multi-story buildings. More specifically, the implemented wireless network can enable the operators of the vertical transport apparatuses to optimize efficiency by automatically detecting worker and object's location and quantity throughout a worksite, and prioritize vertical transport apparatus movement based on worker requests (e.g., requests for quantity, based on request time, and based on the amount of unique people and objects in the immediate proximity of the vertical transport request).

### BACKGROUND

Hoist and vertical transportation on construction sites has long been an antiquated and inefficient process. The current procedure to transport a person or object to one floor from another requires a person to: radio the hoist operator, yet many on-site personnel do not possess a radio device, yell for the hoist operator, or simply wait by the hoist entrance until the hoist passes the floor a person is located at. This is a process that not only compromises the transportation of people and objects in a timely manner, but also threatens the safety of on-site personnel in the wake of an emergency.

Furthermore, when personnel are present on a multi-level site, it is not uncommon for a person to not know the exact floor location they are located at. This poses a few issues in regards to both vertical transportation and safety. Without the knowledge of floor location, it is nearly impossible to request a hoist to a specific location for pick-up, or request needed construction equipment, materials, or people to a requesting employee's location in an efficient manner. There can also be a potential safety concern over site personnel being unaware of their location in the occurrence of an emergency. Not being able to accurately broadcast the precise location of an emergency would severely hinder the response and evacuation time.

Therefore, a need exists in the field of vertical transport for the implementation of a system that enables a hoist (e.g., vertical lift) under control of an operator to efficiently respond to requests for transport and to more accurately and efficiently transport assets (people and objects) to their desired location in a multilevel building. This system should also be capable of sensing a user's general location within a site based on proximity of portable wireless beacons (“roaming beacons”) worn by users roaming about the multilevel building to fixed wireless beacons (“fixed beacons) placed in fixed locations throughout the site. There is also a need to not only sense the user's location, but also to sense equipment and other personnel within that user's immediate proximity when requesting vertical transportation in order to accurately prioritize a user's request with the rest of the multilevel building worksite's hoist requests.

### BRIEF SUMMARY OF THE INVENTION

The present invention includes a teaching of three unique wireless beacons designed for a combination of wearable (e.g., hardhat) adhesion, equipment adhesion, and fixed infrastructure adhesion for providing region identification, two unique mobile applications for on-site personnel and hoist operators, and Edge devices capable of wirelessly transmitting and receiving data to and from the cloud.

Wireless beacons designed for hardhat adhesion so that they can be worn by workers and object (e.g., tools/equipment or material) adhesion enable the Edge devices and mobile applications to sense the presence of these moveable (roaming) asset onsite as well as to identify their last known location. These beacons, given their intended use and nature, can be referred to as “roaming beacons” and also make it possible for a hoist request to automatically detect the quantity and identification of surrounding assets, e.g., people and objects, in the immediate proximity of the request. The third type of wireless beacon is used for region identification and can be affixed to building infrastructure (e.g., locations throughout floors at a multi-level building worksite) and can be referred to as “fixed beacons”. Edge (wireless data communications) devices and mobile applications operable therewith can utilize signals from these beacons (roaming and fixed) to notify both on-site personnel and hoist operators of the general location of workers/objects when a hoist request is issued. These region identifiers can also serve the purpose of updating a user's last known location in a server, as well as the current floor level of the hoist cabs.

At least two unique mobile applications can be considered for use by on-site personnel and the hoist operators, respectively. A first mobile application designed for on-site personnel can be used by personnel (e.g., construction workers) to communicate with the hoist operators and request pick-up, and for mangers (local or remote using Edge communication with a cloud-based service) to locate and track on-site personnel, materials and equipment. A second mobile application can be used by hoist operators to receive hoist requests, set target pick-up locations, and view priority of requests in an organized manner.

In accordance with a method for carrying out the embodiments, more than one roaming beacon can be provided/deployed in the operational environment and including wireless communications and programming to identify and communicate with mobile wireless communications devices also deployed within the operational environment and to receive location information from the at least one beacon at the mobile wireless communications devices. At least one fixed beacon can also be provided supplying identification and location information to a mobile wireless communications device deployed (e.g., carried by a worker or affixed to an object) in the operational environment after the mobile wireless communications device scans the operational environment for surrounding beacons to determine the at least one beacon as the closest beacon based on an indication of signal strength. a push notification can be provided (to a sever, hoist operator, other interested/authorized parties) that includes an alert message and at least one of identification and location information from at least one of a server (e.g., the cloud) or the at least one beacon and mobile wireless communications device (e.g., the worker) to a second party (e.g., hoist operator) based on a type of alert message selected at a mobile wireless communications device used by the second party.

### BRIEF DESCRIPTION OF THE DRAWINGS

Some embodiments of the present invention are illustrated as an example are not limited by the figures of the accompanying drawings, in which like references may indicate similar elements and in which:

FIG. 1 depicts a perspective exemplary view of a wireless beacon device that can be placed on a worker's hardhat and includes an exploded view of hardware/modules that can be included within wireless beacons, according to various embodiments of the present inventions;

FIG. 2 illustrates a perspective view of an exemplary wireless beacon device that can be placed on movable objects, e.g., tool, materials and equipment, according to various embodiments of the present inventions;

FIG. 3 illustrates a perspective view of an exemplary wireless beacon device that can be placed in fixed identifying regions of a multi-story building such as columns or walls within rooms, floors and/or near entrances according to various embodiments of the present invention;

FIG. 4 illustrates an architecture where roaming beacons can communicate with mobile devices, which can communicate with a server via a data network or directly with a hoist operator's device, and the hoist operator's device can communicate with a fixed beacon, in accordance with various embodiments;

FIG. 5 illustrates an a view of a multistory building with an example of a generic hoist apparatus and how wireless beacon devices deployed at a construction site;

FIG. 6 illustrates another view of a floorplan within a multi level building, such as shown in FIG. 4, with a combination of roaming and fixed beacons deployed therein; and

FIG. 7 illustrates a flow diagram of a method in accordance with the embodiments.

### DETAILED DESCRIPTION OF THE INVENTION

Referring to the figures, like numerals indicate like or corresponding parts throughout the views. The present disclosure is to be considered as an exemplification of the invention, and is not intended to limit the invention to the specific embodiments illustrated by the figures or descriptions below.

In describing the invention, it will be understood that numerous techniques and steps are disclosed. Each of these has individual benefit and each can also be used in conjunction with one or more, or in some cases all, of the other disclosed techniques. This description will refrain from repeating every possible combination of the individual steps for sake of clarity, but the specification and claims should be read with the understanding that such combinations are entirely within the scope of the invention and the claims.

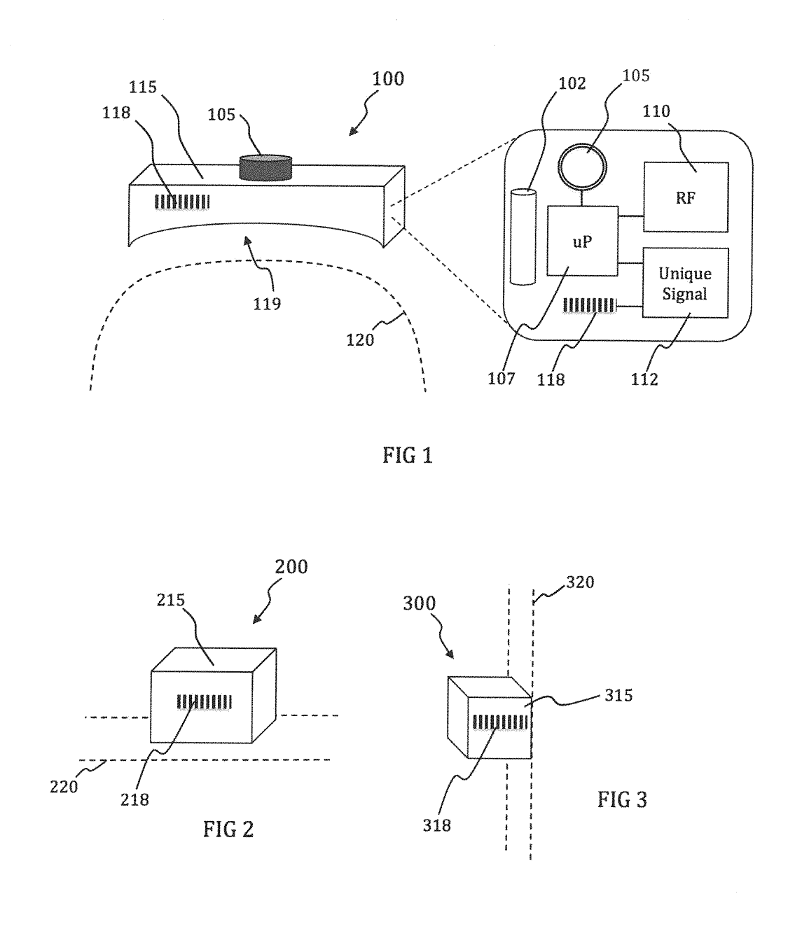

The present invention will now be described by referencing the appended figures representing the preferred embodiments. FIGS. 1-3 depict exploded perspective views of the hardware that can comprise a wireless beacon devices 100/200/300 according to various embodiments of the present invention. Beacons known to be in use as of the time of the present invention are generally small, battery-powered, always-on devices that use BLE (Bluetooth low energy) technology to transmit signals to other devices, such as computers, smartphones and tablets, within a range of about 300 feet. In preferred embodiments, each of the elements of the devices in FIGS. 1-3 can be configured with at least one part of adhesive material (e.g., tape), which can enable the adhesion (securing) of beacons to hardhats, material, tools, equipment, and fixed location within a region of interest (e.g., a multi floor construction site, etc).

The beacon devices 100/200 illustrated in FIGS. 1-2 are intended to be used by/assigned to personnel, tools, equipment, materials and other moving or movable objects/assets that the system can track for their general location at a worksite. This is why they can be referred to generally as “roaming beacons”. As shown in the exploded view of the beacon 100 in FIG. 1, a beacon used to fulfill features of the present invention can be battery powered 102 including communications hardware 110 that can broadcast a unique identifying wireless transmission signal 112 (typically stored in memory) associated with a unique serial number 118 that can further be represented and identified by indicia 118 stamped on or marked onto a surface of the housing 115 for the beacon 100. The unique signal 112 can be broadcast at a specified transmission interval.

The device in FIG. 3 can be attached to fixed location, e.g., columns or walls, and can be referred to as “fixed beacons” used to identify regions at a worksite, such as floors, areas, entries, exits and other stationary physical locations. This fixed beacon device can also be a battery powered beacon device that broadcasts a unique identifying wireless transmission at a specified transmission interval. Together, these three types of wireless beacon devices can supply the necessary identifying and proximity data in the form of wireless signals for the overall system to optimize and automate several aspects of the hoist apparatus.

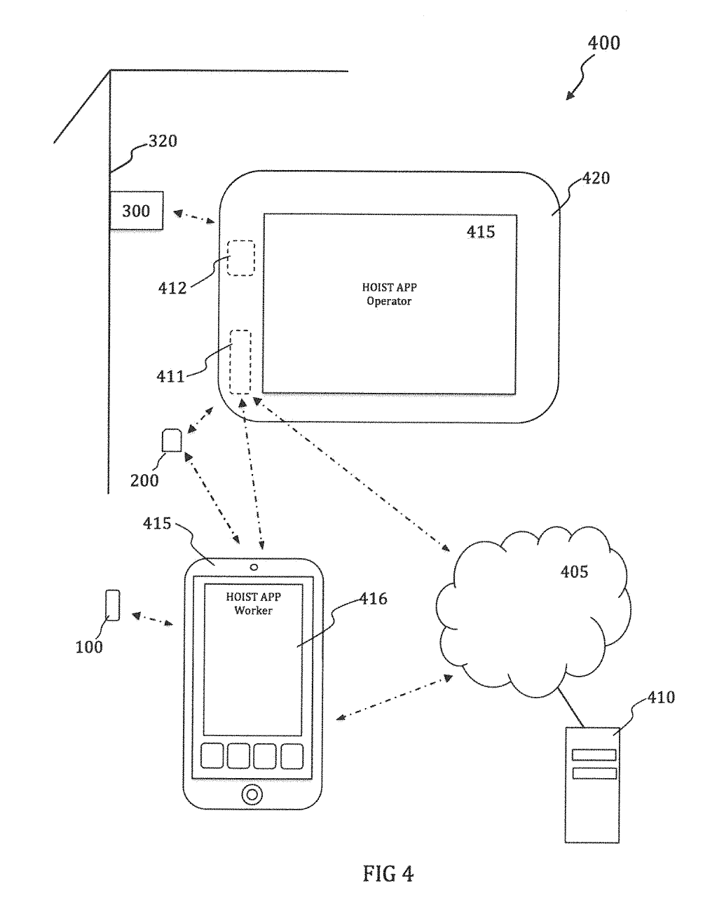

Another feature that can be optionally included in particular with the beacon in FIG. 1 is a push button 105 accessible by a user from a surface of the housing 115, because the beacon 100 in FIG. 1 is intended to be worn by personnel roaming about a worksite. A push button can be used as an alternative and quicker means to make a hoist request without having to physically use a mobile phone application (hoist application as further described in FIG. 4). The button 105 can wirelessly tether (e.g., be paired and connected) to a mobile device 415 (e.g., mobile phone) wherein a mobile application 416 can be used to initiate a hoist request using the cellular or Wi-Fi connection of the mobile device. When a hoist request has been confirmed by the system, the device mentioned in FIG. 1 can confirm that the request has been made via a sensory output including but not limited to a vibration, and/or sound.

Referring to FIG. 4, in order to collect and process the data transmitted by the beacon devices 100/200/300 in FIGS. 1-3, two unique mobile applications can be deployed as well as Edge devices 415/420, (e.g., 4G cellular data telecommunications devices such as mobile phones and tablets) capable of wirelessly transmitting data to the cloud via Wi-Fi and Cellular connection via a data network 405 if necessary. The cloud is generally known to be a network of servers, e.g., server 410, connected to a data network 405, where each server can have a different function. Some servers use computing power to run applications or “deliver a service.” Other servers in the network are responsible for storing data. A first mobile application 415 (e.g., Hoist application for workers) can be used by all on-site personnel and is responsible for communicating with the hoist operator using the hoist application in order to make hoist requests once signals are obtained from beacons 100/200 in communication with the on-site personnel's mobile device 416. Hoist requests can be made through a data network 405/server 410, or via direct communication with the hoist operator device 420. A second mobile application 416 (Hoist application for operators) can be used by the hoist operators and is responsible for the collection and processing of hoist requests that can be received by the hoist operator device 420 directly from the on site personnel mobile device 416 or from the data network 405/server 410. The hoist operator device can also receive signals for fixed beacons 300 and roaming beacons 200/100. Mobile devices 420/415 (e.g., smartphones and tablets) typically include mobile cellular data network communications 411 and short-range RF (e.g., Bluetooth) communications 412 hardware/modules.

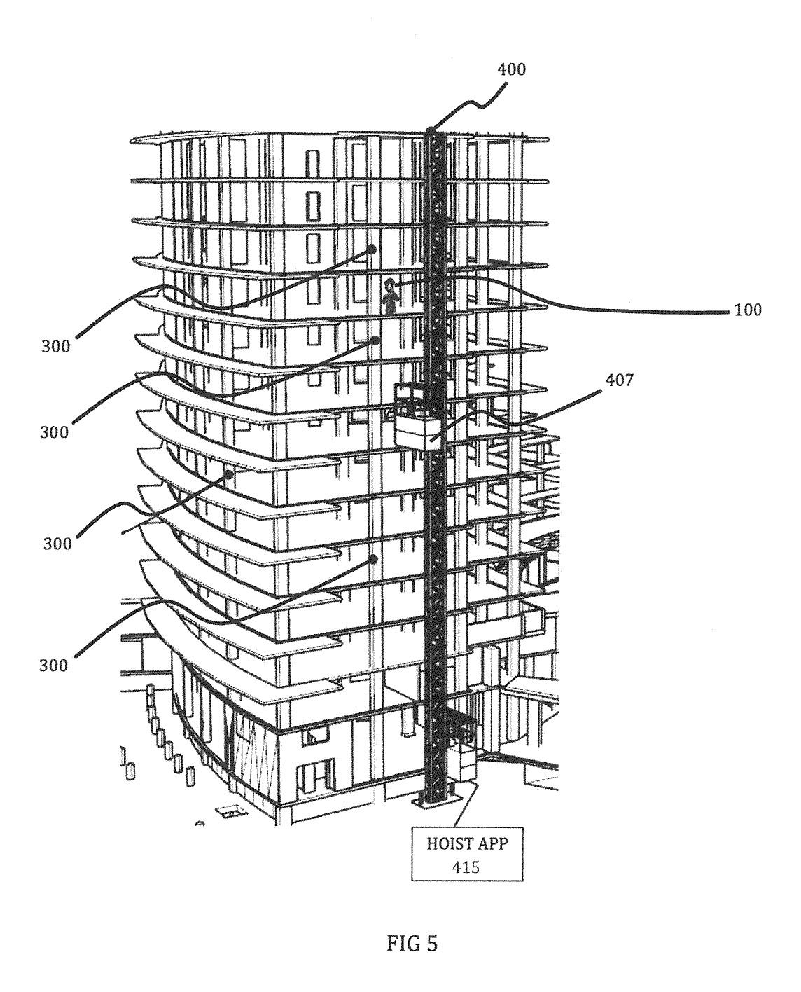

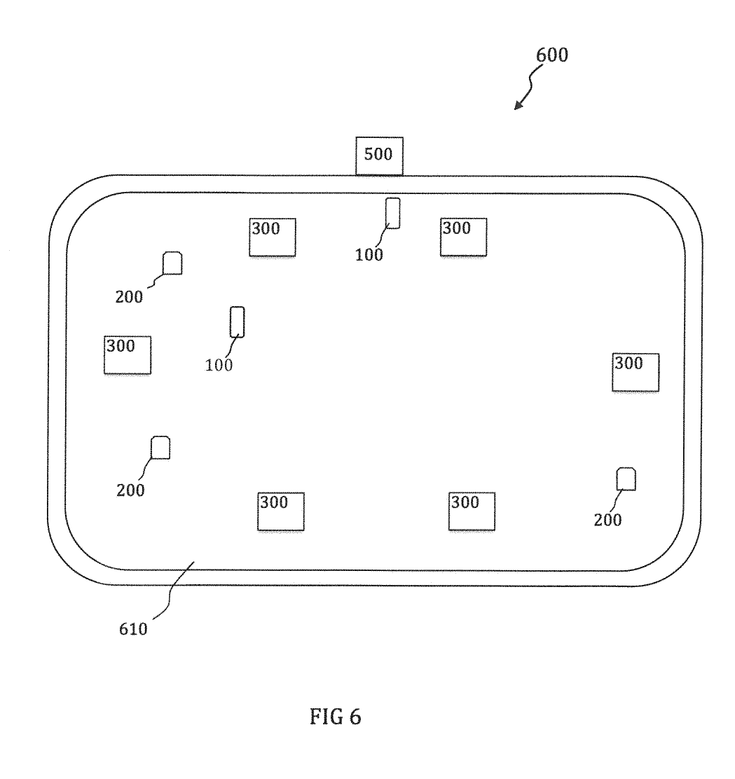

FIG. 5 depicts an exemplary hoist apparatus 500 that the present invention can optimize and automate via wireless beacons and sensor node network applications. The mobile application intended for on-site personnel 416 will use at least one wireless device 415 utilizing a wireless protocol to communicate with hoist operator 507 as well as sense devices as described in FIGS. 1-3 in its proximity. In order for a hoist call to be made by the applications user, the user must first be confirmed to be within the specific location of the hoist 500 in question. The also application can do this, for example, by using the users GPS location coordinates and checking that they are within a previously defined range of coordinates that correspond to the site in question. This is also known as geofencing. Once the user is confirmed to be on the site in which they are requesting vertical transportation from the hoist 500, they can send out a request to the hoist operator 420. It is during this hoist request that the mobile application 416 automatically can detect its current region and detects any surrounding materials, personnel, equipment or other objects that have been equipped with devices as mentioned in FIGS. 1-2. The mobile device application can detect its current general location by scanning for nearby beacon devices 300, which have been predefined (e.g., registered) with a stationary physical location (e.g., columns or fixed wall location). Based on proximity to the devices, the mobile device application 416 can filter the nearest device and include that information with the hoist request. For example, if the user wearing a beacon 100 was to request a hoist at its illustrated position it could request a hoist for the floor the user is located on ant the fixed beacon is registered with, and not for others floors. Similarly, when the application requests a hoist, it can also scan for devices as mentioned in FIGS. 1-2, which have also been predefined with identifying information. This information can also be included with the hoist request for further processing on the mobile application 415 intended for hoist operators only.

The data structure of the hoist request can include, but is not limited to, the request, number of surrounding devices to the request as mentioned in FIG. 1 based on proximity, number of surrounding devices to the request as mentioned in FIG. 2 based on proximity, and current region of the request as determined by proximity to devices mentioned in FIG. 3. Furthermore, there can be an option for select personnel, or VIPs, to make a hoist request that can receive the highest priority on the mobile application intended for the hoist operator which will be described as a “VIP Request” in this preferred embodiment, but is not intended to limit the specific embodiment of this function.

A mobile application intended for use by hoist operators can use at least one wireless protocol to communicate with the on-site personnel using the mobile application described above and the wireless beacon devices described in FIG. 1-3. When a hoist call is made (e.g., transmitted and received by the system) by the user of the first mobile application 416 mentioned above, the hoist operator's application 415 can receive a hoist request with the request, and the number of surrounding devices to the requester as mentioned in FIG. 1 based on proximity, number of surrounding devices to the request as mentioned in FIG. 2 based on proximity, and current region of the request as determined by proximity to devices mentioned in FIGS. 1-3. Using this data, the mobile application can use an algorithm, locally or on a server associated with the cloud, that prioritizes requests based on parameters that include, but are not limited to request time, surrounding devices as mentioned in FIG. 1, surrounding devices as mentioned in FIG. 2, priority of request (i.e. “VIP Request”), and distance from the hoist cab to the request location. These prioritized requests can be listed in the mobile application for the hoist operator to view and react to in real time.

The mobile application can also provide the requesting users mentioned above information regarding the hoist operator's status, location, and heading. The mobile application can automatically update the hoist cab's location by wirelessly detecting the devices 300 mentioned in FIG. 3 and determining its location based on nearest device proximity. The hoist's location status can be updated based on whether or not the mobile hoist application 415 is in use and is on site. If the hoist operator application is not in use, the mobile application intended for on-site personnel 416 can inform users that that specific hoist is offline and vice versa. The mobile application for hoist operators 415 can also allow the hoist operator to specify their target floor in which they intend to pick-up. This information can also be communicated to the user of the mobile application intended for on-site personnel so that they know when to arrive to the hoist cab entrance, thereby further increasing efficiency.

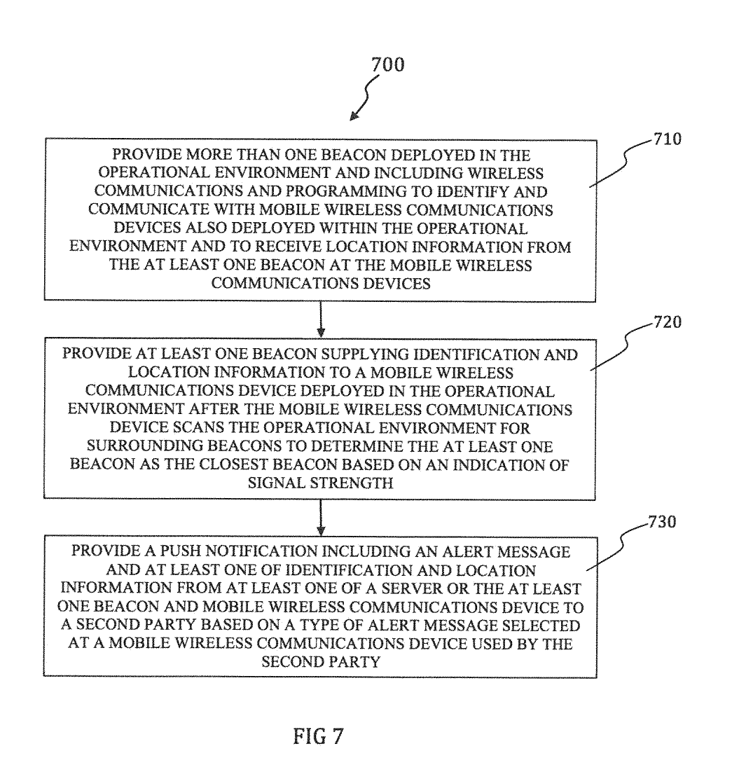

Referring to FIG. 7, a flow diagram illustrating a method that generally summarizes the aforementioned process is provided in accordance with the embodiments. Referring to Block 710, provided is more than one beacon deployed in the operational environment and including wireless communications and programming to identify and communicate with mobile wireless communications devices also deployed within the operational environment and to receive location information from the at least one beacon at the mobile wireless communications devices. Then as shown in Block 720, provided is at least one beacon supplying identification and location information to a mobile wireless communications device deployed (e.g., carried by a worker or affixed to an object) in the operational environment after the mobile wireless communications device scans the operational environment for surrounding beacons to determine the at least one beacon as the closest beacon based on an indication of signal strength. Then, as shown in Block 730, provided is a push notification including an alert message and at least one of identification and location information from at least one of a server (e.g., the cloud) or the at least one beacon and mobile wireless communications device (e.g., the worker) to a second party (e.g., hoist operator) based on a type of alert message selected at a mobile wireless communications device used by the second party.

Although the present invention has been illustrated and described herein with reference to preferred embodiments and specific examples thereof, it will be apparent to those of ordinary skill in the art that other embodiments and examples may perform similar functions and/or achieve like results. All such equivalent embodiments and examples are within the spirit and scope of the present invention, are contemplated thereby, and it is the intent of the inventors that they be covered by the claims.

What is claimed is:

1. A system optimizing vertical lift response to requests for transport of assets to from a first location to a second location along a multilevel building, comprising:
a network of fixed beacons secured to building infrastructure within floors of a multilevel building and in wireless communication with a server via a data communications network;
roaming beacons associated with movable assets located within the multilevel building and also in communication with the server via the data communications network;
a server receiving signals from fixed beacons and roaming beacons and utilizing the signals to determine a location of at least one roaming beacon within the multilevel building based on a proximity of the at least one roaming beacon based on an assessment of the signals; and
a wireless communications device associated with a vertical lift operator adapted to receive requests for transport from the server on behalf of an asset associated with the roaming beacon.

2. The system of claim 1, wherein the vertical lift is a hoist operated by a hoist operator at a multilevel building construction site.

3. The system of claim 1, wherein the roaming beacon's location is used by the server to prioritize requests for the vertical lift.

4. The system of claim 1, wherein the roaming beacon is worn by a requesting user.

5. The system of claim 1, wherein the roaming beacon is worn by a requesting user by adhesion to a hardhat.

6. The system of claim 1, wherein the roaming beacon is attached to movable equipment or material.

7. The system of claim 1, wherein the roaming beacon includes a button to provide a request signal through a wireless communications device.

8. An on-site hoist operating system determining location of assets within multi-story building based on wireless beacon proximity to mobile wireless communications devices associated with the assets as part of a sensor node network, comprising:
more than one beacon deployed throughout floors of the multi-story building and including wireless communications and programming to identify and communicate with mobile wireless communications devices also deployed within the operational environment in association with the assets; and
a server programmed to receive alert notifications from at least one mobile wireless communications device in communications with at least one beacon from the more than one beacons and providing an alert notification to the server that includes the location of the at least one beacon, and wherein the server provides push notifications to a hoist operator based on a type of alert notification received from the at least one mobile wireless communications device.

9. The system of claim 8, further comprising mobile wireless communications devices deployed in the multi-story building, the mobile wireless communications devices including a user interface and programming to enable the mobile wireless communications devices to identify and selectively communicate with the more than one beacons deployed within the multi-story building and adapted to determine the location of a beacon located closest to the mobile wireless communications devices.

10. The system of claim 8, wherein the beacons are Bluetooth low energy beacons.

11. The system of claim 9, wherein the mobile wireless communications devices are carried by workers at a worksite.

12. The system of claim 11, wherein the mobile wireless communications devices includes an application configured to receive signals from at least one roaming beacon and at least one fixed beacon and to submit a hoist request to at least one of a server or hoist operator using the signals.

13. The system of claim 9, wherein a mobile wireless communications device is used by a hoist operator.

14. The system of claim 13, wherein the mobile wireless communications device includes an application configured to receive signals from at least one fixed beacon and to receive a hoist requests from at least one of a server or the mobile communications devices used by workers at the worksite.

15. A method for determining location of assets and asset needs based on beacon proximity and alert notification type, comprising
providing more than one roaming beacon deployed in the operational environment and including wireless communications and programming to identify and communicate with mobile wireless communications devices also deployed within the operational environment and to receive location information from the at least one beacon at the mobile wireless communications devices;
providing at least one fixed beacon supplying identification and location information to a mobile wireless communications device deployed in the operational environment after the mobile wireless communications device scans the operational environment for surrounding beacons to determine the at least one beacon as the closest beacon based on an indication of signal strength; and
providing a push notification including an alert message and at least one of identification and location information from at least one of a server or the at least one beacon and mobile wireless communications device to a second party based on a type of alert message selected at a mobile wireless communications device used by the second party.

16. The method of claim 15, wherein the location information of the at least one beacon is appended to the alert message so the second party will know the location information that the alert came from in relations to the multi-story building.

17. The method of claim 15, wherein the alert message specifies a specific floor within a specific building as the location information.

18. The method of claim 15, wherein location information received from roaming and fixed beacons via the mobile wireless communications devices are provided to a server to process a request for a hoist and the server provides a request notification to a hoist operator at a mobile wireless communications device in use by the hoist operator.
